(19) United States
(12) Patent Application Publication
(10) Pub. No.: US 2011/0027573 A1
(43) Pub. Date: Feb. 3, 2011

(54) Lubricated Abradable Coating

(75) Inventors: Christopher W. Strock, Kennebunk, ME (US); George H. Reynolds, Sanford, ME (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION, Hartford, CT (US)

(21) Appl. No.: 12/534,572

(22) Filed: Aug. 3, 2009

(51) Int. Cl. B32B 3/26; B32B 15/04; B05D 1/36; B05D 5/08; C23C 4/04; B05D 1/08; C23C 4/10

(52) U.S. Cl. 428/319.1; 428/457; 428/450; 428/335; 427/402; 427/419.7; 427/450; 427/452; 427/446

(57) ABSTRACT

A coated article has a metallic substrate. A coating layer comprises at least 33% by volume ceramic, at least 5% by volume of a lubricant selected from the group consisting of hexagonal boron nitride (hBN), clay, graphite, and mixtures thereof. The coating layer lacks a metal phase of more than 5% by volume.

### BACKGROUND

The disclosure relates to turbine engine abradable coatings. More particularly, the disclosure relates to abradable coatings for interfacing with blade tips or vane airfoil tips.

A wide variety of abradable coatings have been proposed for use in gas turbine engines. A particular location of concern is the interface between blade tips and adjacent non-rotating structure (e.g., blade outer air seals (BOAS)). A recent proposal was seen in US20090136740 (the '740 publication). The '740 publication discloses a coating layer comprising a metallic phase, a first ceramic phase and a second ceramic phase. The first ceramic phase may comprise at least one of boron nitride or graphite and the second ceramic phase may comprise at least one of clay or metal oxide.

### SUMMARY

One aspect of the disclosure involves a coated article having a metallic substrate. A coating layer comprises at least 33% by volume ceramic, at least 5% by volume of a lubricant selected from the group consisting of hexagonal boron nitride (hBN), clay, graphite, and mixtures thereof. The coating layer lacks a metal phase of more than 5% by volume.

In various implementations, there may be a bondcoat (e.g., metallic) between the metallic substrate and the coating layer. The coating layer may comprise 35-50% said ceramic and 20-40% said lubricant by volume. The ceramic may consist essentially of a yttria-stabilized-zirconia. The lubricant may comprise said hBN and said hBN may form 5-30% by volume of the coating layer. The lubricant may consist essentially of said hBN, clay, and mixtures thereof. The coating layer may consist essentially of said ceramic and said lubricant.

The article may be in a machine further having a moving component having a motion path extending so that the coating layer forms a rub surface. The coating/rub surface may be on the moving component and/or a fixed component or a second moving component against which the moving component rubs. The coated article may be a blade outer air seal (BOAS) and moving component may be a blade.

Another aspect of the disclosure involves a coated article comprising metallic substrate and a coating layer. The coating layer includes a ceramic matrix and a lubricant within the matrix. The lubricant is selected from the group consisting of hBN, clay, graphite, and mixtures thereof.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a view of a gas turbine engine.

FIG. 2 is an enlarged view of a blade-seal interaction in the engine of FIG. 1.

FIG. 3 is a schematic view of a cantilevered stator vane.

FIG. 4 is a photomicrograph of a coating on a substrate.

FIG. 5 is a photomicrograph of a lubricated ceramic layer in the coating of FIG. 4.

Like reference numbers and designations in the various drawings indicate like elements.

### DETAILED DESCRIPTION

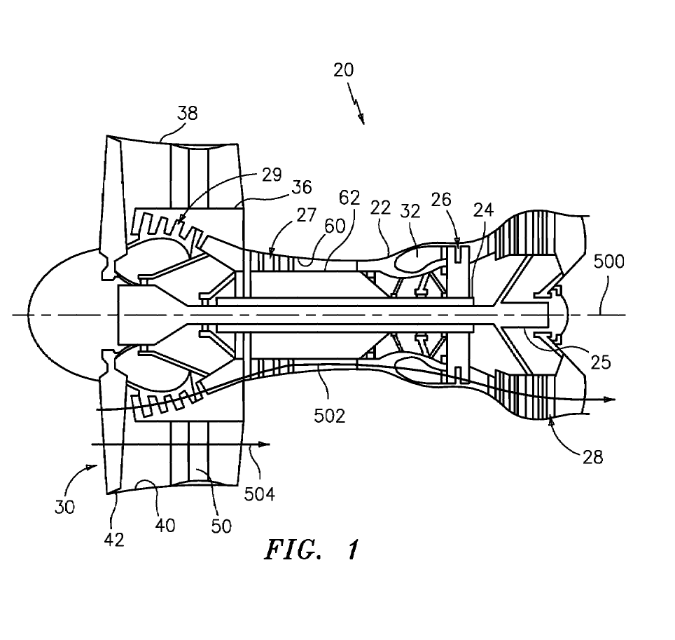

FIG. 1 shows a gas turbine engine 20 having a case assembly 22 containing concentric high and low pressure rotor shafts 24 and 25. The shafts are mounted within the case for rotation about an axis 500 which is normally coincident with central longitudinal axes of the case and shafts. The high speed pressure rotor shaft 24 is driven by the blades of a high speed/pressure turbine (HPT) section 26 to in turn drive the blades of a high speed/pressure compressor (HPC) 27. The low speed/pressure rotor shaft 25 is driven by the blades of a low speed/pressure turbine (LPT) section 28 to in turn drive the blades of a low speed/pressure compressor (LPC) section 29 and a fan 30. In some engines the turbine and/or compressor may have an intermediate speed/pressure section between the high and low sections. Air passes through the engine along a core flowpath 502 sequentially compressed by the low and high compressor sections 29 and 27, then passing through a combustor 32 wherein a portion of the air is combusted along with a fuel, and then passing through the high and low turbine sections 26 and 28 where work is extracted. Additional air is driven by the fan along a bypass flowpath 504. The bypass flowpath extends between an inner case 36 (sometimes identified as an intermediate case) and an outer case or duct 38. A leading portion of the exemplary duct 38 surrounds the fan 30. An inboard surface 40 of the duct 38 is closely spaced apart from fan blade tips 42. To support and hold the duct 38, a circumferential array of fan exit guide vanes (FEGV) 50 may connect the inner case 36 to the duct 38. Various components exposed to gas along the core flowpath 502 have protective coatings (e.g., thermal barrier coatings (TBCs)). In certain locations, such coatings are subject to abrasion from relatively moving parts. A first exemplary area is abrasion by compressor blade or turbine blade tips of the adjacent outboard boundary surface of the core flowpath. The exemplary outboard boundary surface 60 may be formed by one or more sequential circumferential arrays of blade outer air seals. A similar situation arises from abrasion of the inboard boundary surface 62 of the core flowpath by the inboard tips of so-called cantilevered vanes (the outboard ends of which may be formed with shroud segments of the outboard boundary surface 60).

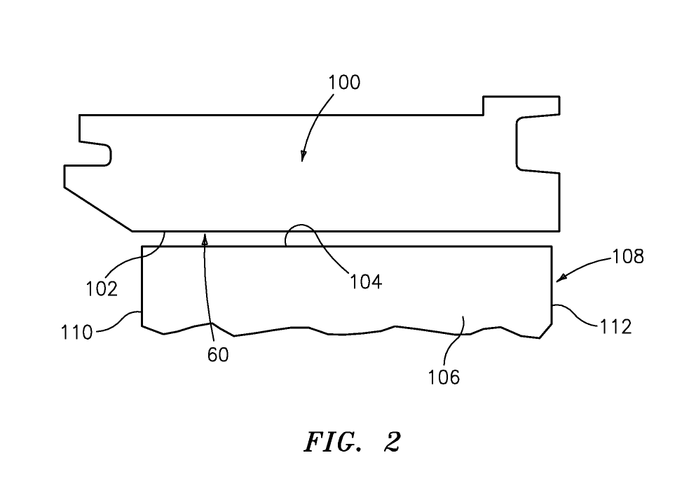

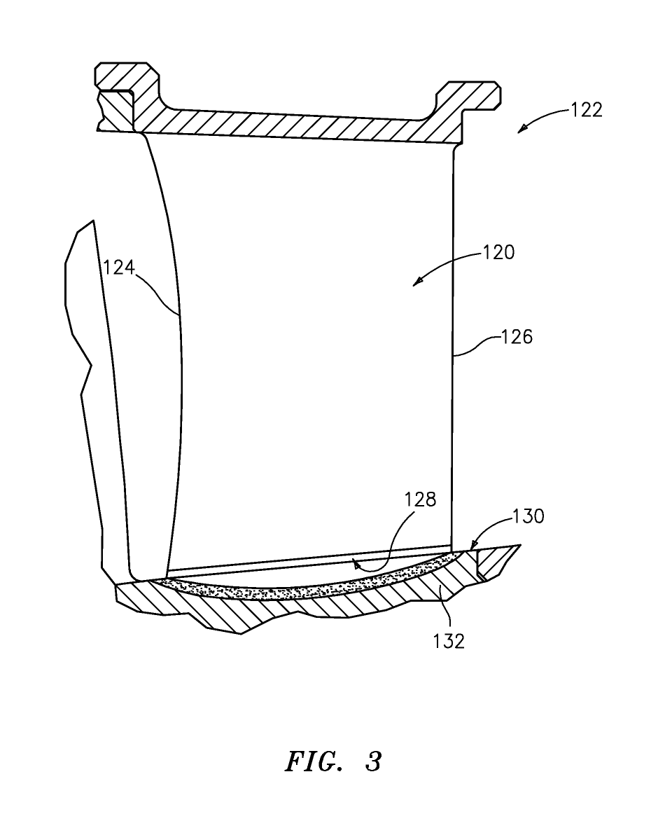

FIG. 2 shows an exemplary BOAS-blade interaction; FIG. 3 shows an exemplary cantilever vane-rotor interaction. In FIG. 2, the individual segment 100 has an ID/inboard surface 102 forming a portion of the outboard boundary surface 60. A circular ring of such segments are positioned with the surfaces/faces 102 in close facing proximity to the tips 104 of the airfoils 106 of an adjacent blade stage 108. The airfoils 108 have respective leading and trailing edges 110 and 112 and pressure and suction sides.

Similarly, FIG. 3 shows the airfoil 120 of a cantilevered vane 122 having a leading edge 124, a trailing edge 126, and an inboard free tip or end 128. The inboard ends 128 of the stage of vanes are in close facing proximity to an adjacent portion of the outer surface 130 of a rotor 132. The surfaces 130 and 102 may have abradable coatings discussed below.

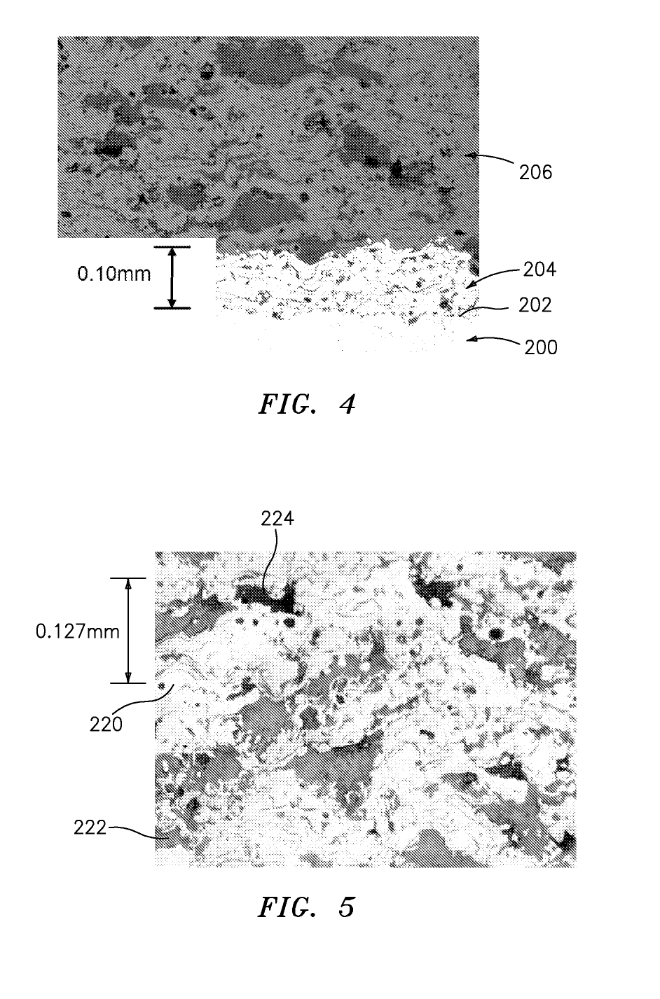

FIG. 4 shows a metallic substrate 200 having a surface 202. The surface may be the ID-surface of the metallic substrate of the BOAS 100 or the OD-surface of the metallic substrate of the rotor 132. Atop the surface 202 is a bondcoat (bondcoat layer) 204. A lubricated ceramic coating 206 is atop the bondcoat 204. The exemplary substrate may be a nickel-based or cobalt-based superalloy or a titanium alloy. An exemplary bondcoat is an MCrAlY alloy (where M identifies one or more of Fe, Ni, and Co) or an aluminde. The exemplary ceramic may comprise a stabilized zirconia, such as yttria stabilized zirconia like 7YSZ.

FIG. 5 shows the coating 206 as including ceramic (light areas) 220. The ceramic forms a matrix containing a solid lubricant (medium tone areas) 222 and separate porosity (dark areas) 224. The abradability of the ceramic combined with the lubrication of the lubricant may help minimize damage to the adjacent airfoil tips upon contact. Exemplary lubricant is selected from the group consisting of hexagonal boron nitride (hBN), clay, graphite, and mixtures thereof. In more particular examples, the lubricant is at least 50% hBN (by volume and/or weight). Such is a mixture of mostly hBN with a smaller amount of clay (e.g., in a 90:10 ratio by weight).

An exemplary bondcoat thickness is 0.005 inch (0.13 mm), more broadly, 0.1-0.2 mm or 0.5-3.0 mm. Exemplary ceramic coating layer thickness is 0.015 inch (0.38 mm, more broadly, 0.3-0.5 mm or 0.2-0.8 mm). Exemplary ceramic density is 33-70% (the remainder occupied by the lubricant and porosity), more narrowly 35-50%. Exemplary lubricant content is 5-50%, more narrowly 20-40% as measured by optical metallography (which treats porosity within the lubricant as if it was lubricant). Exemplary porosity (e.g., not including porosity within lubricant particles as just noted) is 5-30%, more narrowly 10-20%. Such compositions and porosities may be measured as a depth-wise average at a given location or average over an area. Such compositions may also be measured at any individual depth at such location or over such area (as in the case of a coating having a depth-wise gradient in composition or porosity). Overall, the ceramic coating layer may consist essentially of the ceramic, lubricant, and porosity (or porosity-formers prior to bake-off as is discussed further below). An exemplary content of such ceramic, lubricant, and porosity is at least 95% by volume. More particularly, essentially 100%. This, for example, is distinguished from metal-based coatings or coatings with substantial metal phases as are disclosed in US20090136740. Thus, separate metal phases may account for an exemplary no more than 5% of the volume, more particularly essentially none.

The exemplary airfoils may comprise metallic substrates either with or without coatings along the airfoil tips. One example is a nickel-based superalloy with an uncoated tip. The presence of the solid lubricant reduces the friction of the tip-to-seal (or rotor) rub and may reduce metal galling/transfer from the airfoil to the seal (or rotor). This can directly improve efficiency and life of both the airfoil and seal (or rotor). To the extent that the presence of lubricant reduces porosity, blow-by flow (of air or other gas) through the porosity may be reduced, thereby also improving efficiency. Heat generation and transfer to the seal substrate may similarly be reduced from the reduced friction and from the reduced porosity. The reduced heat transfer and reduced flow of air through the coating may reduce the formation of thermally grown oxides (TGO) atop the bond coat. An alternative exemplary airfoil is a titanium alloy having an abrasive tip coating (e.g., an aluminum oxide). In such a system the presence of the lubricant may have similar benefits to those described above including increasing life of the tip coating. Yet other embodiments might involve use of a similar lubricated coating on the tip in addition to the seal (or rotor). Particular benefits may be present where the coated surface is a rotor. Metal transferred from the airfoil is has a lower tendency to adhere to the ceramic/solid lubricant coating contrasted with a coating having a substantial metallic phase. Centrifugal action may cause transferred metal to harmlessly shed (whereas a buildup could cause centrifugal loading to spall/delaminate the rotor coating). The reduction of buildup can also permit tighter design clearances.

A variety of application techniques are possible. These include various thermal spray techniques, high velocity oxy-fuel (HVOF) techniques, and the like. Particular exemplary bond coat application techniques include air plasma spray, low pressure plasma spray (LPPS), vacuum plasma spray (VPS), and HVOF. Particular exemplary application techniques for the ceramic coating layer are air plasma spray and VPS. A more particular exemplary coating application combination is via air plasma spray, first of the bondcoat and then of the ceramic coating layer. Exemplary application of the ceramic coating layer may be via a blend of the ceramic, lubricant, and porosity-formers. In the exemplary lubricant blend of hBN and bentonite clay, the hBN and bentonite may initially be mixed and dispersed in water to form a slurry. The slurry may be spray dried to produce a mixture of particles. The mixture of particles (subject to appropriate size sorting) may provide improved flowability in spray equipment. Exemplary porosity-formers are polyester or methylmethacrylate or other polymer. As-deposited, the porosity-formers produce polymer phases within the ceramic coating layer. These polymer phases may be baked out to leave porosity (e.g., via a separate baking stage or upon use). Exemplary baking temperatures are at least 500° F. (260° F.) for methylmethacrylate and 900° F. (482° F.) for polyester. Alternative application techniques for the ceramic coating layer may be via separate introduction of the powders into the spray plume or codeposition of the powders with separate respective spray torches.

One or more embodiments have been described. Nevertheless, it will be understood that various modifications may be made. For example, when applied to an existing engine, details of the engine configuration and materials may influence details of any particular implementation. Accordingly, other embodiments are within the scope of the following claims.

What is claimed is:

1. A coated article comprising:
a metallic substrate; and
a coating layer comprising:
at least 33% by volume ceramic; and
at least 5% by volume of a lubricant selected from the group consisting of: hexagonal boron nitride (hBN); clay;
graphite; and mixtures thereof, the coating layer not having a metal phase of greater than 5% by volume.

2. The coated article of claim 1 wherein the coating layer comprises:
35-50% by volume said ceramic; and
20-40% by volume said lubricant.

3. The coated article of claim 1 wherein:
the ceramic consists essentially of a yttria-stabilized-zirconia.

4. The coated article of claim 1 wherein:
the stabilized zirconia is a yttria stabilized zirconia.

5. The coated article of claim 1 wherein:
the lubricant comprises said hBN; and
said hBN forms 5-30% by volume of the coating layer.

6. The coated article of claim 1 wherein:
the lubricant consists essentially of said: hBN; clay; graphite; and mixtures thereof.

7. The coated article of claim 1 wherein:
the coating layer consists essentially of said ceramic and said lubricant.

8. The coated article of claim 1 further comprising:
a bondcoat between the substrate and the coating layer.

9. The coated article of claim 8 wherein:
the bondcoat has a thickness of 0.1-0.2 mm; and
the coating layer has a thickness 0.3-0.5 mm.

10. The coated article of claim 1 wherein:
said coating layer has 5-30% by volume porosity.

11. The coated article of claim 1 being a blade outer air seal wherein:
the coating layer is at least along an inner diameter (ID) face.

12. The coated article of claim 1 being a rotor wherein:
the coating layer is at least along an outer diameter (OD) surface.

13. A machine comprising:
the coated article of claim 1; and
a component having a motion path relative to the article extending so that the coating layer forms a rub surface for the component.

14. The machine of claim 13 wherein:
the coated article is a blade outer air seal and the component is a blade; or the coated article is a rotor and the moving component is a vane.

15. A method for forming the coated article of claim 1 comprising:
codepositing the ceramic and the lubricant.

16. The method of claim 15 wherein the codepositing comprises:
thermal spraying of said ceramic; and
thermal spraying of said lubricant.

17. The method of claim 15 wherein the codepositing comprises:
codepositing with a fugitive material, the fugitive material being deposited in a volume amount of 5-30% of the coating layer.

18. A coated article comprising:
a metallic substrate; and
a coating layer comprising:
a ceramic matrix; and
a lubricant within the matrix, the lubricant selected from the group consisting of hexagonal boron nitride (hBN);
clay; graphite; and mixtures thereof.

19. A method for coating a substrate, the method comprising simultaneous:
thermal spraying of a ceramic; and
thermal spraying of a solid lubricant.

20. The method of claim 19 further comprising:
codepositing a fugitive material with said ceramic and said solid lubricant.
